(19) United States
(12) Patent Application Publication
(10) Pub. No.: US 2007/0028197 A1
(43) Pub. Date: Feb. 1, 2007

(54) METHOD AND APPARATUS FOR AUTO-GENERATION OF SHIFT REGISTER FILE FOR HIGH-LEVEL SYNTHESIS COMPILER

(75) Inventors: Yudhi SANTOSO, Tai Seng Industrial Estate, (SG); Wei Lee NEW, Tai Seng Industrial Estate, (SG)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/460,396

(22) Filed: Jul. 27, 2006

(30) Foreign Application Priority Data
Jul. 29, 2005 (JP) 2005-220279

(51) Int. Cl. G06F 17/50

(52) U.S. Cl. 716/3

(57) ABSTRACT

A method and apparatus for auto-generation of shift register file for high-level synthesis compiler includes parsing input source codes for specific definition of shift register file, a plurality of compiler directives to indicate the shift register file name, shift register file size, shift register file read access order, and shift register file write timing of the specific shift register file. The invention also includes determining the shifting interval of shift register file with specific definition after each reading or writing automatically. The invention further includes determining if the shift register file with specific definition has been generated, generating shift register file with specific definition if it has not been generated, and generating shift register file control signals to access the shift register file with specific definition. The invention additionally includes accessing shift register file with specific definition for reading or writing both in a one-dimensional or two-dimensional manner.

### BACKGROUND OF THE INVENTION

1. Field of the Invention

This invention relates to auto-generation of shift register file for high-level synthesis compiler in a digital circuit.

2. Description of the Related Art

The technology in increasing the number of gates that can be put in one chip has advanced remarkably. In order to design and develop a digital circuit in a short period of time efficiently, high-level synthesis converts the behavioural description of a very large scale integrated (VLSI) circuit into a structural, register-transfer level (RTL) implementation. A circuit designer may start with a behavioural description, which contains an algorithmic specification of the functionality of the circuit. The RTL implementation describes an interconnection of macro blocks (e.g., functional units, registers, multiplexers, buses, memory blocks, etc.) and random logic.

A behavioural description of a sequential circuit may contain almost no information about the cycle-by-cycle behaviour of the circuit or its structural implementation. High-level synthesis (HLS) tools typically compile a behavioural description into a suitable intermediate format, such as Control-Data Flow Graph (CDFG). High-level synthesis tools typically perform one or more of the following tasks: transformation, module selection, clock selection, scheduling, resource allocation and assignment (also called resource sharing or hardware sharing). High-level synthesis technique has been described in details in “High-Level Synthesis: Introduction to Chip and System Design”, Kluwer Academic Publishers, 1992 by Daniel Gajski, Nikill Dutt, Allen Wu, and Steve Lin.

As the implementation of high-level synthesis tools increases, the efficiency and the effectiveness of these tools for circuit design and development are desired by a circuit designer such as area reduction and low power dissipation optimization. Based on the behavioural description which is usually input by a circuit designer, the high-level synthesis tool must be able to provide a circuit design satisfying the predefined requirements for particular algorithm.

Encoding and decoding algorithm utilising one-dimensional or two dimensional arrays such as Discrete Cosine Transform (DCT), Inverse Discrete Cosine Transform (IDCT), Inverse Quantization (IQ), Finite Impulse Response (FIR) filter, Fast Fourier Transform (FFT) and Inverse Fast Fourier Transform (IFFT), etc can be implemented using one-dimensional or two-dimensional shift register. An example of this implementation is the JPEG standard as described in Wallace, “The JPEG still picture compression standard”, IEEE Transactions on Consumer Electronics, vol. 34, No. 4, pp. 30-44, April 1991, which utilises two-dimensional Discrete Cosine Transform and Inverse Discrete Cosine Transform for encoding and decoding, respectively. However, the problems encountered in conventional shift register are the number of logic circuits required to implement them. As the number of registers increase in a shift register file, the required logic circuits are also increased.

FIG. 1 illustrates the implementation of a shift register file utilising a large multiplexer for decoding the address of each register. The large multiplexer contributes to a significant increase in chip area. Each time one specific register is to be read or written, the multiplexer will output one of its input register to output register according to the decoded address. Utilising the behaviour of encoding and decoding algorithm implementation, an efficient shift register file generation for high-level synthesis compiler has been devised,

### SUMMARY OF THE INVENTION

According to one aspect of the present invention, there is provided a method of auto-generation of shift register file for high-level synthesis compiler. The method comprises parsing input source codes for specific definition of shift register file, a plurality of compiler directives to indicate the shift register file name, shift register file size, shift register file read access order, and shift register file write timing of the specific shift register file. The method also comprises determining the shifting interval of shift register file with specific definition after each reading or writing automatically. Furthermore, the method comprises determining if the shift register file with specific definition has been generated, generating shift register file with specific definition if it has not been generated, and generating shift register file control signals to access the shift register file with specific definition. The method additionally comprises accessing shift register file with specific definition for reading or writing either in a one-dimensional or two-dimensional manner.

According to another aspect of the present invention, there is provided apparatus for auto-generation of shift register file for high-level synthesis compiler. The apparatus comprises means for parsing input source codes for specific definition of shift register file and compiler directives means to indicate the shift register file name, shift register file size, shift register file read access order, and shift register file write timing of the specific shift register file. The apparatus also comprises determining the shifting interval of shift register file with specific definition after each reading or writing automatically. The apparatus further comprises means for determining if the shift register file with specific definition has been generated and means for generating shift register file with specific definition if it has not been generated. The apparatus also comprises means for generating shift register file control signals to access the shift register file with specific definition. The apparatus additionally comprises means for accessing shift register file with specific definition for reading or writing either in a one-dimensional or two-dimensional manner.

According to a further aspect of the invention, there is provided apparatus for auto-generation of shift register file for high-level synthesis compiler operable according to the method of the first aspect.

According to yet another aspect of the invention, there is provided a computer program product having a computer program recorded on a computer readable medium, for auto-generation of shift register file for high-level synthesis compiler. The computer program product comprises computer program code means for parsing input source codes for specific definition of shift register file and compiler directives means to indicate the shift register file name, shift register file size, shift register file read access order, and shift register file write timing of the specific shift register file. The product also comprises computer program code means for determining the shifting interval of shift register file with specific definition after each reading or writing automatically. The product further comprises computer program code means for determining if the shift register file with specific definition has been generated and means for generating shift register file with specific definition if it has not been generated. The product further comprises computer program code means for generating shift register file control signals to access the shift register file with specific definition. The product additionally comprises computer program code means for accessing shift register file with specific definition for reading or writing either in a one-dimensional or two-dimensional manner.

According to again a further aspect of the invention, there is provided a computer program product having a computer program recorded on a computer readable medium, for auto-generation of shift register file for high-level synthesis compiler operable according to the method of the first aspect.

Embodiments of the invention can be used to provide interactive interfaces to high-level synthesis tools to specify the definition of shift register file and to generate shift register file with specific definition that are within scope specified by a developer, for an assortment of chip development requirements and algorithm requirements.

### BRIEF DESCRIPTION OF THE DRAWINGS

The invention is described by way of non-limitative example with reference to the accompanying drawings, in which:

FIG. 1 is an illustration of large multiplexer used in conventional shift register file access;

FIG. 2 is an overview flowchart relating to the operation of an embodiment of the invention;

FIG. 3 is an illustration of the use of compiler directives and built-in functions to define specific shift register file generation and to specify its parameter;

FIG. 4 is an illustration of the timing interval of writing to a shift register file using a predefined shifting mechanism;

FIG. 5 is an illustration of the timing interval of reading from a shift register file using a predefined shifting mechanism;

FIG. 6 is a flowchart illustrating shift register file generation and its control signal generation for high-level synthesis compiler;

FIG. 7 is a block diagram illustrating write mode signal generation for one-dimensional shift register file;

FIG. 8 is a block diagram illustrating write mode signal generation for two-dimensional shift register file;

FIG. 9 is a block diagram illustrating read mode signal generation for two-dimensional shift register file;

FIG. 10 is an illustration of a one-dimensional shift register file generated by high-level synthesis compiler;

FIG. 11 is an illustration of a two-dimensional shift register file generated by high-level synthesis compiler;

FIG. 12 is an illustration of a two-dimensional shift register file implementation using a predefined shifting mechanism;

FIG. 13 is an illustration of a computer system for implementing the apparatus and processes associated with the exemplary embodiment.

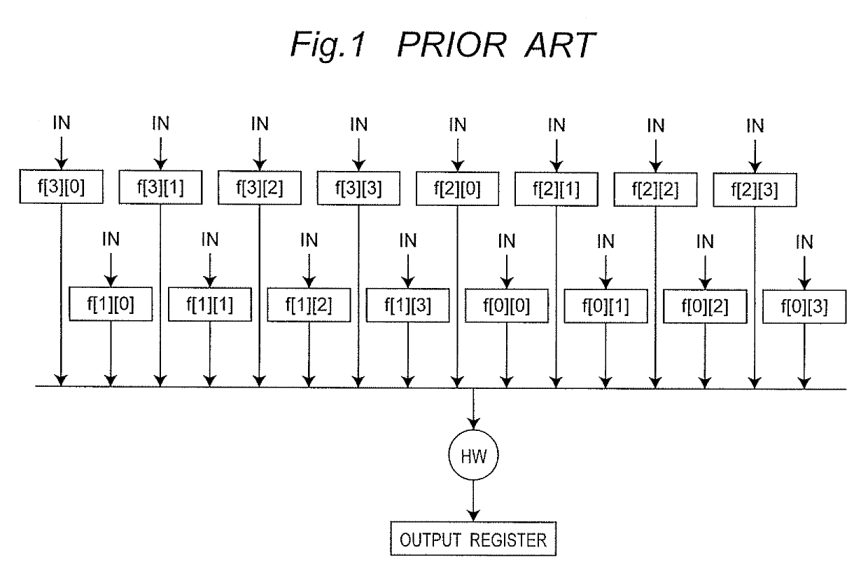

### DETAILED DESCRIPTION OF THE PREFERRED EMBODIMENTS

The described embodiment uses what may be termed auto-generation of shift register file hardware in high-level synthesis. The embodiment uses compiler directives to give definition of the shift register file used in input source code and to automatically generate shift register file hardware based on the specified definition.

The described embodiments of the invention are part of scheduling phase and data path allocation phase of high-level synthesis, with auto-generation of shift register file as the task to accomplish. A developer can decide whether shift register file is to be generated through a plurality of compiler directives. Moreover, the developer can decide the access of shift register file through two sets of built-in functions either to read or to write the shift register file.

The plurality of compiler directives set the specific definition of shift register file and comprises shift register file name, shift register file size, shift register file read access order, and shift register file write timing. The two sets of built-in functions for accessing the shift register file with specific definition can be used to determine whether it is to read or to write the shift register file with specific definition.

The described embodiments can be used to generate a RTL design consisting of shift register file access without a complicated address generator yielding in a reduced chip area. The developer can describe the implementation of shift register file in a RTL design according to the chip requirements and algorithm requirements.

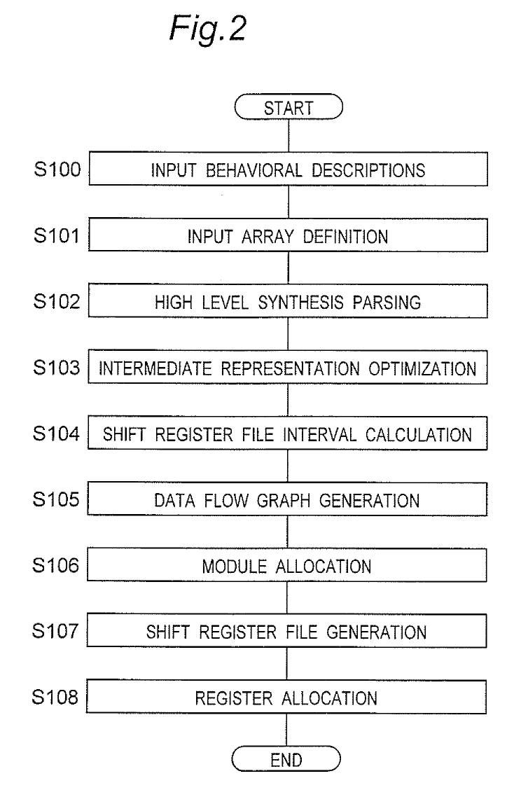

FIG. 2 is an overview flowchart relating to the operation of an embodiment of the invention, to generate shift register file automatically based on specific definition of the shift register file given by a developer.

A behavioural description of a circuit is provided as input (Step S100). This may be input by a machine or by a user using an interface such as keyboard or a graphical user interface. Array definition is input (Step 101) through a plurality of compiler directives specified in the source codes.

The behavioural description and the array definition are parsed (Step 102) by a high-level synthesis compiler. An intermediate representation is also optimised (Step 103), by any one of several known ways. Common techniques to optimize intermediate representations include software pipelining, loop unrolling, instruction parallelizing scheduling, force-directed scheduling, etc. These methods are usually applied cooperatively to optimize intermediate representations.

The shifting interval of shift register file to be generated is calculated (Step 104) during scheduling phase. The timing interval of shift register file is integrated with other operations and variables to generate the scheduled data flow graph (DFG). A data flow graph representation is scheduled (Step S105) using the compiled input behavioural description. Data path is allocated based on the scheduled DFG using any one of several known ways such as cliques partitioning, left-edge algorithm, weighted bipartite algorithm, etc. In data path allocation, module allocation (Step 106) is completed first, followed by shift register file generation (Step 107), and register allocation (Step 108).

Shift register file hardware is generated (Step S107) based on the parsed input array definition (S101) and the calculated shifting interval of shift register file (S104). The parsed input array definition contains the shift register file name, shift register file size, shift register file read access order and shift register file write timing. The shift register file read access order and shift register file write timing will be used to specify the access order of reading and writing the register file. The shifting interval of shift register file will be used to specify when to shift the shift register file after each writing or reading. The shift register file hardware generation stops when the shift register file with specific definition has been generated and/or accessed according to the parsed input array definition and the two sets of built-in functions.

Compiler Directives

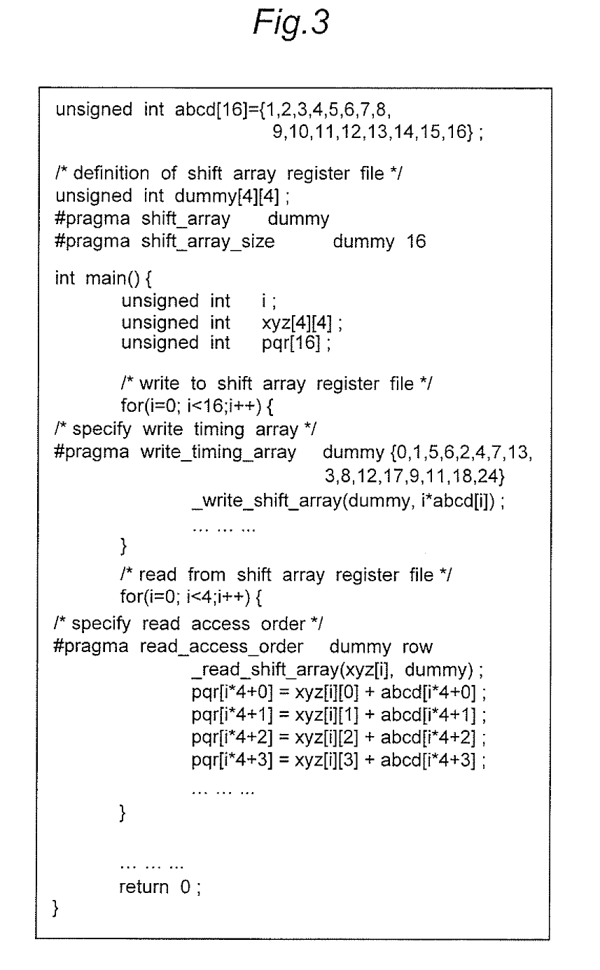

FIG. 3 is an illustration of the use of compiler directives and built-in functions to define specific shift register file generation and to specify its parameter. A plurality of compiler directives give the circuit developer finer control over the auto-generation of shift register file. A plurality of compiler directives are inserted at the beginning of a function's source code and allow user to specify the shift register file name, shift register file size, shift register file read access order, and shift register file write timing. These comment (pragma) facilities allow a user to specify a shift register file with efficient addressing without requiring a complicated address decoder as in conventional shift register file. The two sets of built-in functions are used to determine the access mode of the shift register file.

An example of the use of such a plurality of compiler directives is shown in FIG. 3, written in C source code, where user defines the shift register file name, shift register file size, shift register file read access order, and shift register file write timing. The shift register file read access order and shift register write timing must be specified before _read_shift_array( ) and _write_shift_array( ) built-in functions, respectively. The shift register read access order and _read_shift_array( ) built-in function can be specified many times to read the shift register file with specific definition either in a row order or in a column order. The shift register write timing and _write_shift_array( ) built-in function can be specified many times to write the shift register file with specific definition in a random order according to index number, in a row order, or in a column order.

The shift_array directive specifies the shift register file name and the shift_array_size directive specifies the shift register file size. In a one-dimensional shift register file, the shift_array_size directive value will be the size of the one-dimensional array; meanwhile, in a two-dimensional N×N shift register file, where N is the size of the array, the shift_array_size directive value will be the number of total elements in the array as specified by N×N. The number of elements in the row direction and column direction of shift register file should be of the same number, e.g. 2×2, 4×4, 8×8, etc.

The read_access_order directive specifies the manner in which the shift register file will be read. In a one-dimensional shift register file, only row-shift access will be allowed. In a two-dimensional shift register file, if ‘row’ is assigned to read_access_order directive, then the two-dimensional shift register file will be read one row at a time. If ‘col’ is assigned to read_access_order directive, then the two-dimensional shift register file will be read one column at a time. The read_access_order directive must be specified together with built-in function _read_shift_array( ) if the circuit developer wants to read the shift register file with specific definition in a specified manner.

The write_timing_array directive specifies the manner in which the shift register file will be written. In a one-dimensional shift register file, if ‘row’ is assigned to write timing array directive, then the one-dimensional shift register file will be written one row at a time. If an array of index number having total number of elements according to the shift register file size is assigned to write_timing_array directive, then the one-dimensional shift register file will be written according to index number specified in the array. In a two-dimensional shift register file, if ‘row’ is assigned to write_timing_array directive, then the two-dimensional shift register file will be written one row at a time. If ‘col’ is assigned to write_timing_array directive, then the two-dimensional shift register file will be written one column at a time. If an array of index number having total number of elements according to the shift register file size is assigned to write_timing_array directive, then the two-dimensional shift register file will be written according to index number specified in the array. The write_timing_array directive must be specified together with built-in function _write_shift_array( ) if the circuit developer wants to write to the shift register file with specific definition in a specified manner.

The access mode of the shift register file with specific definition is defined by the built-in functions illustrated in FIG. 3.

The _write_shift_array( ) built-in function specifies the write access mode of the shift register file with specific definition as given by a plurality of compiler directives. Two parameters are specified to _write_shift_array( ) built-in function, i.e. the destination shift register file with specific definition and the source value to be written to the shift register file with specific definition. The write_timing_array directive must be specified before the function call to _write_shift_array( ) built-in function to specify the manner in which the shift register file with specific definition should be written.

The _read_shift_array( ) built-in function specifies the read access mode of the shift register file with specific definition as given by a plurality of compiler directives. Two parameters are specified to _read_shift_array( ) built-in function, i.e. the destination variable and the source shift register file with specific definition to be read. The read_access_order directive must be specified before the function call to _read_shift array( ) built-in function to specify the manner in which the shift register file with specific definition should be read. In FIG. 3, the add operation after _read_shift_array( ) built-in function will have to be delayed by the shifting interval of the shift register file because the output of the shift register file will be available after each shifting interval In this case, the read access order is one row at a time, therefore, the add operation after _read_shift_array( ) built-in function is delayed by one-row shifting interval of shift register file.

Example of Shift Register Timing Interval

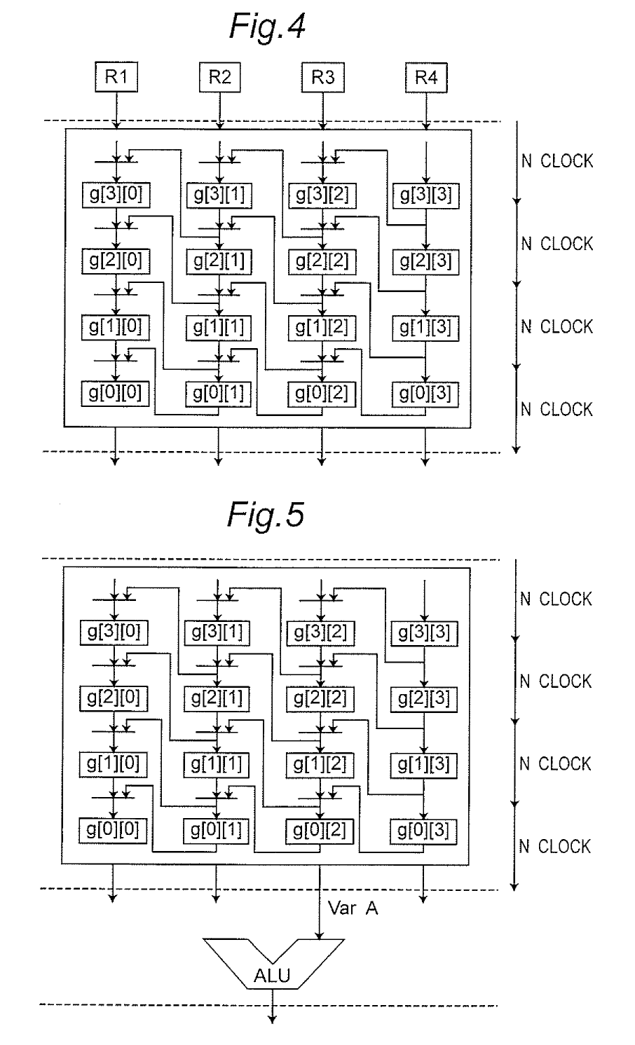

FIG. 4 is an example of the calculation of timing interval for writing to a shift register file using a predefined shifting mechanism. The shift register file is written from the first row, and then each row will be down-shifted by one row. The shifting interval to write each row of the shift register file will be N clock cycles. Therefore, the input registers R1, R2, R3, R4 will be written to the first row of shift register file concurrently within N clock cycles, and then the shift register file will be down-shifted by one row. The next writing of shift register file will take N clock cycles again for one row and so on. The writing is completed when all rows of shift register file have been written with data.

FIG. 5 is an example of the calculation of timing interval for reading from a shift register file using a predefined shifting mechanism. The shift register file is read from the last row, and then each row will be down-shifted by one row. The shifting interval to read each row of the shift register file will be N clock cycles. Therefore, the arithmetic logical unit (ALU) will have to be delayed until the output from the shift register file becomes available.

Shift Register File Generation

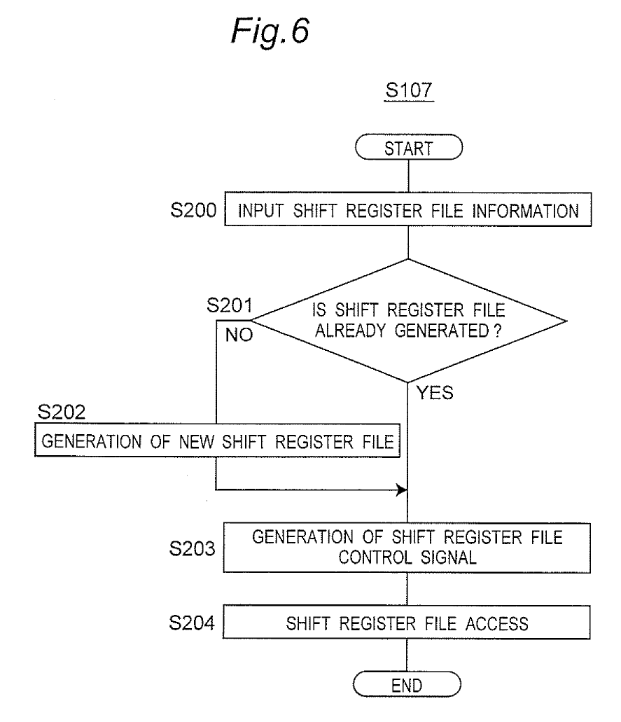

FIG. 6 is a flowchart illustrating shift register file generation and its control signals generation for high-level synthesis compiler. After the calculation of shift register shifting interval in scheduling phase and module allocation in data path of high-level synthesis, the shift register file generation is started. The parsed input array information S200 comprising of shift register file name, shift register size, shift register read access order, and shift register write timing is used to determine if the shift register shift file with specific definition has already generated (S201).

If the shift register file with specific definition has been generated before, then the control signal to access the shift register file with specific definition is generated (S203). If the register file with specific definition has not been generated before, then the generation of shift register file with specific definition (S202) is required. After the shift register file with specific definition is generated, then the control signal to access the shift register file with specific definition is generated (S203).

In the generation of control signal of shift register file with specific definition (S203), the built-in functions _write_shift_array( ) and _read_shift_array( ) are used to determine if the access mode of the shift register file with specific definition is read or write access mode. If the access mode is read access mode, then the generation of read control signal for shift register file with specific definition is required. If the access mode is write access mode, then the generation of write control signal for shift register file with specific definition is required. In both read and write access mode, the shifting interval of shift register file calculated during scheduling phase will be used to generate the control signals for shift register file with specific definition.

After the read or write control signals generation for shift register file with specific definition, the shift register file access (S204) can be executed. According to parsed input array definition, the one-dimensional or two-dimensional shift register file with specific definition will be read or written in a manner which is determined by the read_access_order or write_timing_array directives, respectively.

Shift Register File Control

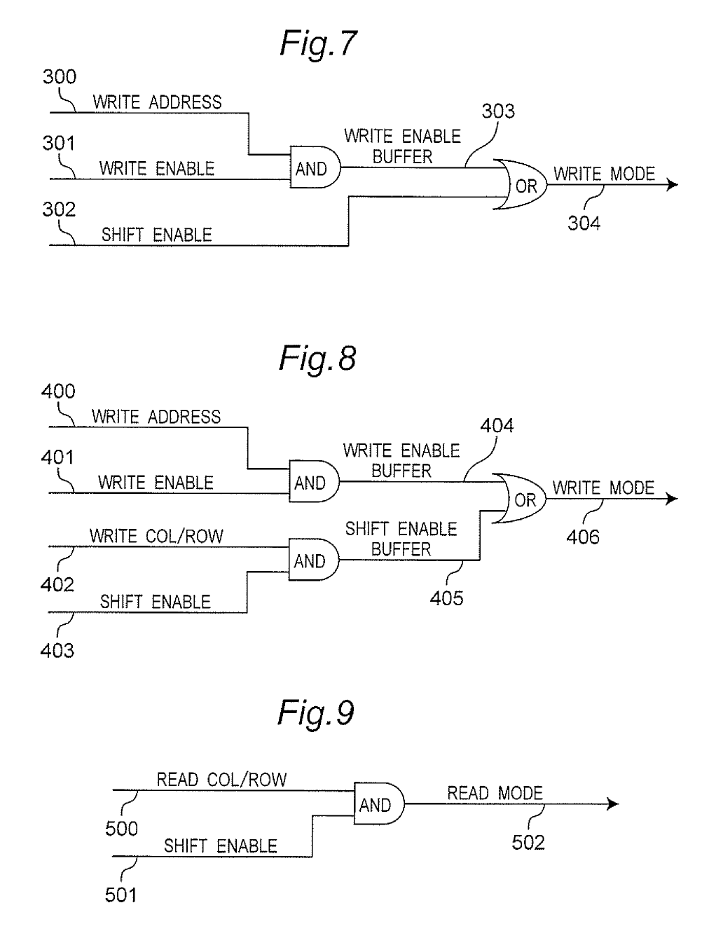

FIG. 7 shows a block diagram illustrating write mode signal generation for one-dimensional shift register file with specific definition. The write mode signal is used to control the write access mode of the shift register file with specific definition. In a one-dimensional shift register file with specific definition, whether it is to write in a random order according to index number in write_timing_array directive or to write one row at a time is controlled by the write mode signal. The write address 300 of the element number indicated in write_timing_array directive and the write enable signal 301 are used to generate the write enable buffer 303 if the shift register file with specific definition is to be written in a random manner according to index number in write_timing_array directive. Shift enable 302 for row-shift write access is OR-ed together with write enable buffer 303 to generate the write mode signal 304.

Read mode signal generation for a one-dimensional shift register file with specific definition will be generated by shift enable signal. Since a one-dimensional shift register file with specific definition can only be read one row at a time, the shift enable signal will be used to generate the read mode signal.

FIG. 8 shows a block diagram illustrating write mode signal generation for two-dimensional shift register file with specific definition. The write mode signal is used to control the write access mode of the shift register file with specific definition. In a two-dimensional shift register file with specific definition, whether it is to write in a random order according to index number in write_timing_array directive, to write one row at a time, or to write one column at a time is controlled by the write mode signal. The write address 400 of the element number indicated in write_timing_array directive and the write enable signal 401 are used to generate the write enable buffer 404 if the shift register file with specific definition is to be written in a random manner. Write col/row signal 402 is the value obtained from write_timing_array directive. The write col/row signal 402 and shift enable 403 are used to generate the shift enable buffer 405. Shift enable buffer 405 will determine if the shift register file with specific definition will do row-shift or column-shift after writing. Write enable buffer 404 is OR-ed together with shift enable buffer 405 to generate the write mode signal 406 for a two-dimensional shift register file with specific definition.

FIG. 9 shows a block diagram illustrating read mode signal generation for two-dimensional shift register file with specific definition. Read mode signal 502 will be generated by shift enable signal 501 and read col/row signal 500 obtained from read_access_order directive. The read col/row signal 500 will determine if the reading of shift register file with specific definition will be one row at a time or one column at a time. Shift enable signal 501 is AND-ed together with read col/row signal 500 to generate the read mode signal 502.

One-Dimensional Shift Register File

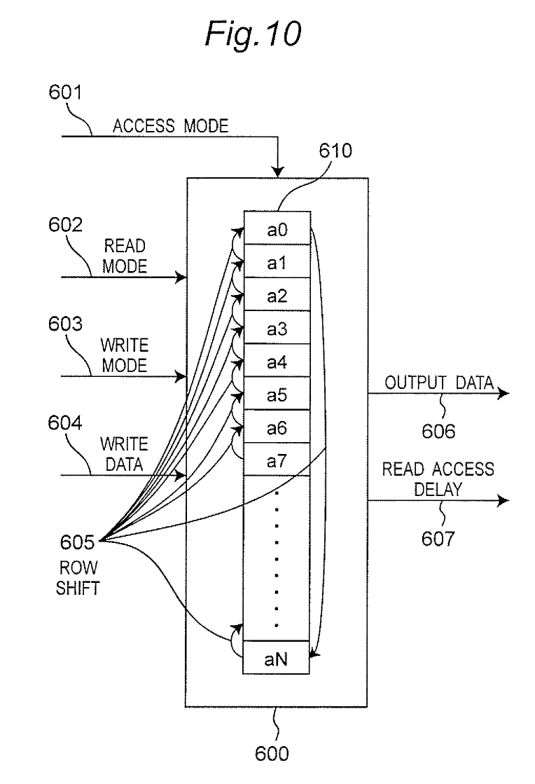

FIG. 10 illustrates a one-dimensional shift register file generated by high-level synthesis compiler. The one-dimensional shift register file with specific definition 600 receives the access mode signal 601, read mode signal 602, write mode signal 603, and write data 604. The one-dimensional shift register file with specific definition 600 generates the output data 606 and read access delay 607 if the access mode is to read the one-dimensional shift register file with specific definition 600.

The access mode 601 determines whether the one-dimensional shift register file with specific definition 600 is to be read or written. If the one-dimensional shift register file with specific definition 600 is to be read, then output data 606 will be output one row at a time. According to read mode signal 602, the shift register file with specific definition 600 will be read one row at a time. For example, if the first element 610 of the one-dimensional shift register file with specific definition will be read first, then the one-dimensional shift register file with specific definition 600 will be up-shifted one row at a time 605. The first element 610 of the one-dimensional shift register file with specific definition 600 will be shifted to the last row of the one-dimensional shift register file with specific definition 600. Read access delay 607 will also be generated if access mode is to read the shift register file with specific definition 600. The read access delay 607 will be input to registers or functional units to determine the write enable of registers or to delay the execution of operations until the output data 606 of shift register file with specific definition is available.

If the one-dimensional shift register file with specific definition 600 is to be written, then there will be no output data 606 and no read access delay 607. The write mode signal 603 will determine if the one-dimensional shift register file with specific definition 600 should be written in a random manner according to the values in write_timing_array directive or one row at a time. The write data 604 contains the data to be written to the one-dimensional shift register file with specific definition 600. For example, if the last row of the one-dimensional shift register file with specific definition 600 will be written first, then the one-dimensional register file with specific definition 600 will be up-shifted one row at a time 605 until all data has been written to the one-dimensional shift register file with specific definition 600.

Two-Dimensional Shift Register File

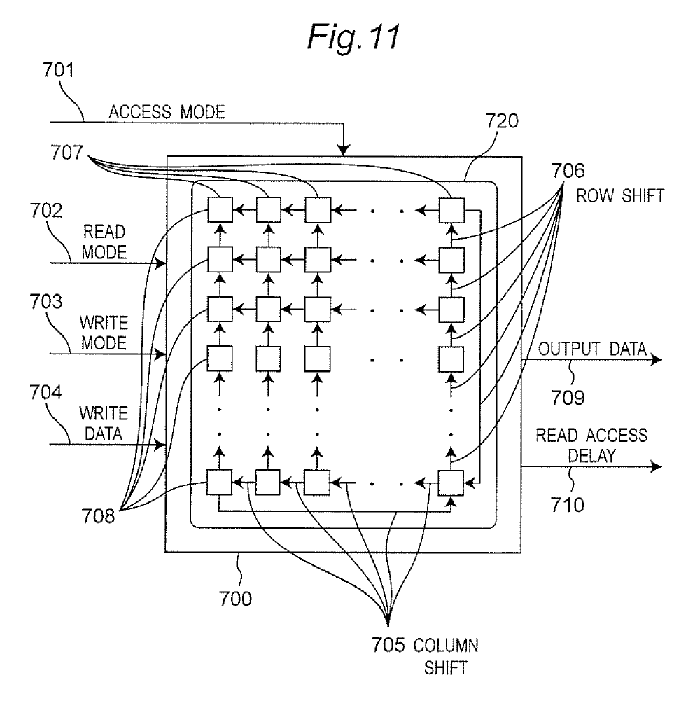

FIG. 11 illustrates a two-dimensional shift register file generated by high-level synthesis compiler. The two-dimensional shift register file with specific definition 700 receives the access mode signal 701, read mode signal 702, write mode signal 703, and write data 704. The two-dimensional shift register file with specific definition 700 generates the output data 709 and read access delay 710 if the access mode is to read the two-dimensional shift register file with specific definition 700.

The access mode 701 determines whether the two-dimensional shift register file with specific definition 700 is to be read or written. If the two-dimensional shift register file with specific definition 700 is to be read, then output data 709 will be output either one row at a time or one column at a time. If the two-dimensional shift register file with specific definition 700 is to be written, then will be no output data 709 and no read access delay 710.

The read mode signal 702 determines whether the two-dimensional shift register file with specific definition 700 should be read one row at a time or one column at a time. For example, if the two-dimensional shift register file with specific definition 700 is to be read from the first row 707, then the two-dimensional shift register file with specific definition 700 will be up-shifted one row at a time 706. If the two-dimensional shift register file with specific definition 700 is to be read from the first column 708, then the two-dimensional shift register file with specific definition 700 will be left-shifted one column at a time 705.

The write mode signal 703 will determine whether the two-dimensional shift register file with specific definition 700 should be written in a random manner according to write_timing_array directive, one row at a time, or one column at a time as illustrated in FIG. 11. If the two-dimensional shift register file with specific definition 700 is to be written in a random manner according to write_timing_array directive, then the write data 704 will be written randomly according to the write address in the write mode signal 703. If the last row of the two-dimensional shift register file with specific definition 700 is to be written first, then the two-dimensional shift register file with specific definition 700 will be up-shifted one row at a time 706 until all data has been written to the two-dimensional shift register file with specific definition 700. If the last column of the two-dimensional shift register file with specific definition 700 is to be written first, then the two-dimensional shift register file with specific definition 700 will be left-shifted one column at a time 705 until all data has been written to the two-dimensional shift register file with specific definition 700.

Example of Shift Register File Implementation

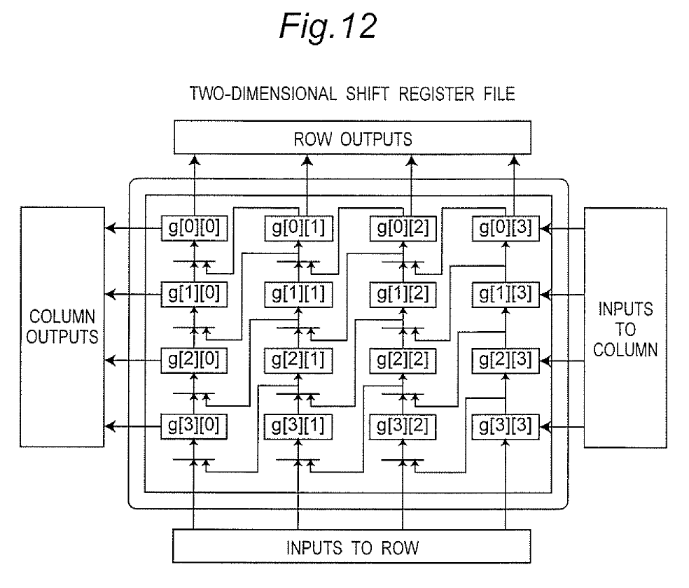

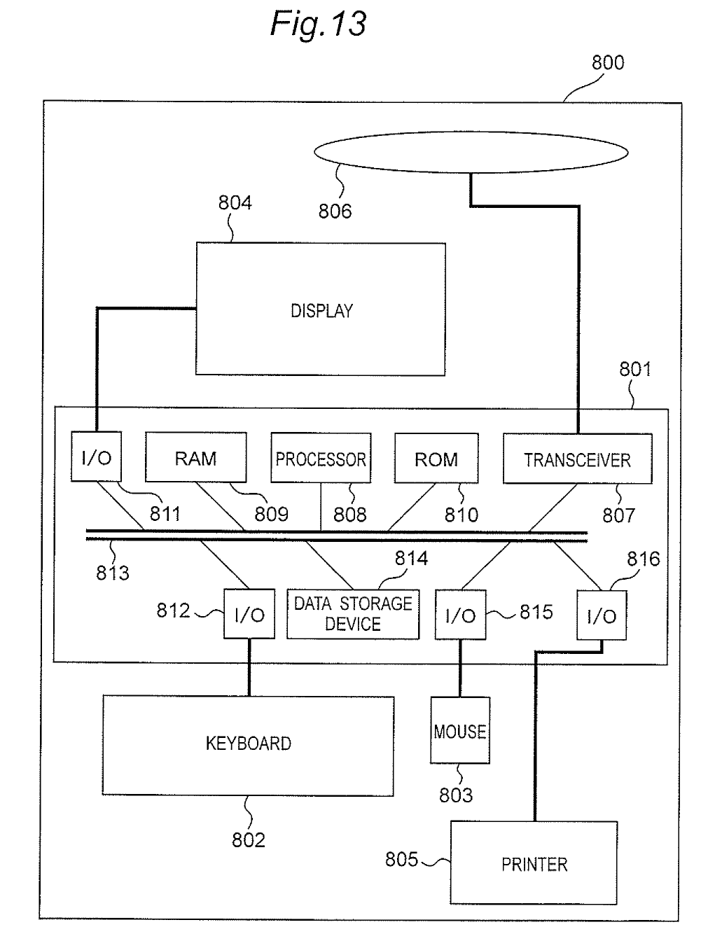

FIG. 12 is an illustration of a two-dimensional shift register file implementation 720 using a predefined shifting mechanism shown previously in FIG. 11. The two-dimensional shift register file with specific definition is implemented using many 2-to-1 multiplexers instead of one large multiplexer. This kind of implementation results in a significant reduction in circuit area due to the elimination of a complicated address decoder. In FIG. 12, the shift register file with specific definition takes input one column at a time starting from the last column and then left-shifted by one column. The shift register file with specific definition also takes input one row at a time starting from the last row and then up-shifted by one row. The shift register file with specific definition produces output one column at a time starting from the first column and then left-shifted by one column. The shift register file with specific definition also produces output one row at a time starting from the first row and then up-shifted by one row.

The apparatus and processes of the exemplary embodiments can be implemented on a computer system 800, for example as schematically shown in FIG. 10. The embodiments may be implemented as software, such as a computer program being executed within the computer system 800, and instructing the computer system 800 to conduct the method of the example embodiment.

The computer system 800 comprises a computer module 801, input modules such as a keyboard 802 and mouse 803 and a plurality of output devices such as a display 804, and printer 805.

The computer module 801 is connected to a computer network 806 via a suitable transceiver device 807, to enable access to e.g. the Internet or other network systems such as Local Area Network (LAN) or Wide Area Network (WAN).

The computer module 801 in the example includes a processor 808, a Random Access Memory (RAM) 809 and a Read Only Memory (ROM) 810. The computer module 801 also includes a number of input/output (I/O) interfaces, for example an I/O interface 811 to the display 804, an I/O interface 812 to the keyboard 802, an I/O interface 815 to the mouse 803, and an I/O interface 816 to the printer 805. The keyboard 802 may, for example be used by the chip designer to specify the definition of the shift register file according to the requirements and needs of the algorithm implementation.

The components of the computer module 801 typically communicate via an interconnected bus 813 and in a manner known to the person skilled in the relevant art.

The application program is typically supplied to the user of the computer system 800 encoded on a data storage medium such as a CD-ROM or floppy disc and read utilising a corresponding data storage medium drive of a data storage device 814. The application program is read and controlled in its execution by the processor 808. Intermediate storage of program data may be accomplished using the RAM 809.

### EFFECTS OF THE INVENTION

The method and apparatus for auto-generation of shift register file for high-level synthesis compiler utilises a plurality of compiler directives. With the auto-generation of efficient shifting mechanism for register file, the circuit design generated by the high-level synthesis compiler yields a reduced area because the address generator for accessing data stored in various registers is either significantly simplified or not needed. Encoding and decoding algorithm utilising one-dimensional or two dimensional arrays such as Discrete Cosine Transform (DCT), Inverse Discrete Cosine Transform (IDCT), Inverse Quantization (IQ) Finite Impulse Response (FIR) filter, Fast Fourier Transform (FFT), etc can be implemented efficiently by using high-level-synthesis compiler. The significant area reduction achieved by using shifting mechanism of register file and the auto-generation of shift register file can further reduce production cost and time to market, which are the deciding factors in circuit design.

The above embodiments are described with reference to auto-generation of shift register file for high-level synthesis compiler to an electronic circuit, for instance for a decoder or encoder. However, the processes described could be used for auto-generation of shift register file in high-level synthesis compiler for other circuits, such as an optical/photonic one, as would readily be understood by the man skilled in the art.

In the foregoing manner, a method and apparatus for auto-generation of shift register file for high-level synthesis compiler are disclosed. Only several embodiments are described but it will be apparent to one skilled in the art in view of this disclosure that numerous changes and/or modifications may be made without departing from the scope of the invention

1. A method of auto-generation of shift register file for high-level synthesis compiler comprising:
(a) parsing input source codes for shift register file with specific definition;
(b) determining the shifting interval of the shift register file with specific definition;
(c) determining if the shift register file with specific definition has been generated before;
(d) generating the shift register file with specific definition if the shift register file with specific definition has not been generated before; and
(e) generating the shift register file control signals to access the shift register file with specific definition.

2. A method according to claim 1, wherein parsing input source codes for shift register file with specific definition comprises parsing a plurality of compiler directives indicating the shift register file with specific definition.

3. A method according to claim 2, wherein parsing a plurality of compiler directives comprises parsing the shift register file name, shift register file size, shift register read access order, and shift register write timing.

4. A method according to claim 2, wherein further parsing input source codes for shift register file with specific definition comprises parsing a plurality of built-in functions to access the shift register file with specific definition.

5. A method according to claim 3, wherein said shift register file name is the name of the array to be implemented as shift register file with specific definition in circuit design.

6. A method according to claim 3, wherein said shift register file size is total number of elements in the array to be implemented as shift register file with specific definition in circuit design.

7. A method according to claim 31 wherein said shift register file read access order is the manner in which the shift register file with specific definition is to be read either one row at a time or one column at a time.

8. A method according to claim 31 wherein said shift register file write timing is the manner in which the shift register file with specific definition is to be written in a random order according to the index number, one row at a time, or one column at a time.

9. A method according to claim 4, wherein said a plurality of built-in functions is read built-in function to read data stored in the shift register file with specific definition and write built-in function to write data into the shift register file with specific definition.

10. A method according to claim 2, wherein said shift register file read access order is to be used in conjunction with said read built-in function to access the data stored in the shift register file with specific definition.

11. A method according to claim 2, wherein said shift register file write timing is to be used in conjunction with said write built-in function to write data into the shift register file with specific definition.

12. A method according to claim 2, wherein determining the shifting interval of the shift register file with specific definition comprises determining the shifting interval of each row or column after each writing according to said write timing or after each reading according to said read access order.

13. A method according to claim 1, wherein determining if the shift register file with specific definition has been generated before comprises finding the shift register file with said specific name and said specific size.

14. A method according to claim 13, further comprising generating the shift register file with specific definition if the shift register file with specific definition has not been generated before.

15. A method according to claim 1, wherein generating the shift register file control signals to access the shift register file with specific definition comprises determining if the access to the shift register file with specific definition is to read or to write according to said a plurality of built-in functions.

16. A method according to claim 15, further comprising generating the read mode signal to read the data stored in the shift register file with specific definition or the write mode signal to write data into the shift register file with specific definition.

17. A method according to claim 16, wherein said read mode signal is generated by using the input shift enable signal and read row/column signal corresponding to said shift register file read access order if the read order is either one row at a time or one column at a time.

18. A method according to claim 17, wherein said write mode signal is generated by using the input write address corresponding to the random write order specified by said shift register file write timing, the write enable signal, shift enable signal, and write row/column signal corresponding to said shift register file write timing if the write order is either one row at a time or one column at a time.

19. A method according to claim 1 wherein the shift register file with specific definition is either one or two dimensional.

20. A method according to claim 1, further comprising generating one dimensional shift register file with specific definition having access mode, read mode, write mode, write data as inputs and read data, read access delay as outputs.

21. A method according to claim 1, further comprising generating two dimensional shift register file with specific definition having access mode, write mode, write data, read mode as inputs and read data and read access delay as outputs.

22. A method according to claim 18, wherein said one-dimensional shift register file with specific definition is read one row at a time and then up-shifted or down-shifted by one row if said read mode is one row at a time.

23. A method according to claim 18, wherein said one-dimensional shift register file with specific definition output the data and read access delay if said access mode is to read the shift register file with specific definition.

24. A method according to claim 18, wherein said read access delay is the delay in which said one-dimensional shift register file will provide output data according to said read mode.

25. A method according to claim 18, wherein said two-dimensional shift register file with specific definition is read one row at a time and then up-shifted or down-shifted by one row if said read mode is one row at a time.

26. A method according to claim 18, wherein said two-dimensional shift register file with specific definition is read one column at a time and then left-shifted or right-shifted by one column if said read mode is one column at a time.

27. A method according to claim 18, wherein said two-dimensional shift register file with specific definition is written one row at a time and then up-shifted or down-shifted by one row if said write mode is one row at a time.

28. A method according to claim 18, wherein said two-dimensional shift register file with specific definition is written one column at a time and then left-shifted by one column if said write mode is one column at a time.

29. A method according to claim 18, wherein said two-dimensional shift register file with specific definition output the data and read access delay if said access mode is to read the shift register file with specific definition.

30. A method according to claim 18, wherein said read access delay is the delay in which said two-dimensional shift register file will provide output data according to said read mode.

31. A method according to claim 1, further comprising inputting array definition.

32. A method according to claim 1, wherein the generating the shift register file is for a circuit in high-level synthesis compiler.

33. A method according to claim 1, wherein generating the shift register file is for an electronic circuit in high-level synthesis compiler.

34. Apparatus for auto-generation of shift register file for high-level synthesis compiler comprising:
means for parsing input source codes for shift register file with specific definition;
means for determining the shifting interval of the shift register file with specific definition;
means for determining if the shift register file with specific definition has been generated before;
means for generating the shift register file with specific definition if the shift register file with specific definition has not been generated before; and
means for generating the shift register file control signals to access the shift register file with specific definition.

35. A program recorded on a computer readable medium, for auto-generation of shift register file in high-level synthesis compiler, said program comprising:
computer program code for parsing input source codes for shift register file with specific definition;
computer program code for determining the shifting interval of the shift register file with specific definition;
computer program code for determining if the shift register file with specific definition has been generated before;
computer program code for generating the shift register file with specific definition if the shift register file with specific definition has not been generated before; and
computer program code for generating the shift register file control signals to access the shift register file with specific definition.

36. A program recorded on a computer readable medium, according to the method of claim 1.
